(19) United States
(12) Patent Application Publication
(10) Pub. No.: US 2010/0221948 A1
(43) Pub. Date: Sep. 2, 2010

(54) LABELLING ASSEMBLY

(75) Inventors: Kevin Truskett, Kincumber (AU); Bryce Nicholls, Green Point (AU)

Correspondence Address: MERCHANT & GOULD PC, P.O. BOX 2903, MINNEAPOLIS, MN, 55402-0903, US

(73) Assignee: ADC GmbH, Berlin (DE)

(21) Appl. No.: 12/713,864

(22) Filed: Feb. 26, 2010

(30) Foreign Application Priority Data
Feb. 27, 2009 (AU) 200900800

(51) Int. Cl. H01R 3/00

(52) U.S. Cl. 439/491

(57) ABSTRACT

A labelling assembly for identifying wire connection locations of a wire termination module, including a fastener for coupling the assembly to the module; a label member for bearing labelling indicia for identifying the wire connection locations; and a bracket for supporting the label member in a position overlying the wire connection locations, wherein the bracket is adapted to support the label member in a first position where a first row of said wire connection locations is laid open for external connection to insulated conductors and a second position where a second row of said wire connection locations is laid open for external connection to insulated conductors.

This application claims benefit of Serial No. 200900800, filed 27 Feb. 2009 in Australia and which application is incorporated herein by reference. To the extent appropriate, a claim of priority is made to the above disclosed applications.

### TECHNICAL FIELD OF THE INVENTION

The present invention relates to a labelling assembly for identifying wire connection locations of a wire termination module.

### BACKGROUND OF THE INVENTION

In many networks, particularly in the telecommunications industry, parts of the network may have multiple wire connections between nodes. For example, a house may have five phone lines installed, in which case five twisted pairs of insulated conductors (hereafter referred to as “wires”) will run between the house and an external telecommunications terminal.

To allow for ease of connection and disconnection, the pairs of wires running from the house may be connected to a wire termination module, also referred to as a cross connect block, which connects pairs of wires running from the house to corresponding pairs of wires running to the external telecommunications terminal. There are many advantages of a system that uses such a termination module when compared with a system that directly connects the house and terminal. In the above-mentioned example, where the house has five telephone lines installed, only two lines may be in use. In this case, five pairs of wires will run from the house to the termination module to allow for future expansion and five corresponding pairs of wires will run to the terminal. The wire termination module will be configured to cross connect two pairs of wires running from the house to two pairs of wires running to the terminal. Later, if the subscriber at the house wishes to add a new line for a fax machine, for example, a technician would only need to configure the module to cross connect another pair of wires running from the house to a corresponding pair of wires running to the exchange.

By virtue of their application, wire termination modules generally have multiple wire connection locations. The large number of wire connection locations may make it difficult for a technician to uniquely identify a specific wire termination location for connection/disconnection of a particular wire. This may be particularly the case where a large number of incoming and outgoing wires are connected to the module. The difficulty of the technician's job may be further increased if the wire termination module forms part of a bank of multiple wire termination modules. The above described difficulties may be further exacerbated as time progresses and the need include more transmission lines in already confined spaces increases.

It is generally desirable to overcome or ameliorate one or more of the above mentioned difficulties, or at least provide a useful alternative.

### SUMMARY OF THE INVENTION

In accordance with one aspect of the invention, there is provided a labelling assembly for identifying wire connection locations of a wire termination module, including:
(a) a fastener for coupling the assembly to the module;
(b) a label member for bearing labelling indicia for identifying the wire connection locations; and
(c) a bracket for supporting the label member in a position overlying the wire connection locations,
   wherein the bracket is adapted to support the label member in a first position where a first row of said wire connection locations is laid open for external connection to insulated conductors and a second position where a second row of said wire connection locations is laid open for external connection to insulated conductors.

Preferably, the label member is a generally rectangular plate.

Preferably, the label member is a generally rectangular frame shaped to receive and display a card bearing labelling indicia.

In accordance with another aspect of the invention, there is provided a wire termination module, including:
(a) a housing formed in front and back parts;
(b) first and second rows of wire connection locations arranged in parallel on a common side of the housing; and
(c) a fastener for coupling the above described labelling assembly.

### BRIEF DESCRIPTION OF THE DRAWINGS

FIG. 1 is a front perspective view of a labelling assembly coupled to a wire termination module;

FIG. 2 is a section view of the labelling assembly shown in FIG. 1 through the line “X”-“X”;

FIG. 3 is a front perspective view of the wire termination module shown in FIG. 1;

FIG. 4 is a top view of the labelling assembly and wire termination module shown in FIG. 1 arranged in another condition of use;

FIG. 5 is a front perspective view of the labelling assembly and wire termination module shown in FIG. 1 arranged in yet another condition of use;

FIG. 6 is a front perspective view of the labelling assembly and wire termination module shown in FIG. 1 arranged in still another condition of use;

FIG. 7 is a front perspective view of another labelling assembly;

FIG. 8 is a front perspective view of the labelling assembly shown in FIG. 7 coupled to a card;

FIG. 9 is a front perspective exploded view of the labelling assembly coupled to a wire termination module;

FIG. 10 is a front perspective view of the labelling assembly shown in FIG. 9;

FIG. 11 is a section view of the labelling assembly shown in FIG. 10 through the line Y-Y;

FIG. 12 is a section view of the labelling assembly shown in FIG. 11 with the label member arranged in another condition of use; and

FIG. 13 is a section view of the labelling assembly shown in FIG. 11 with the label member arranged in yet another condition of use.

### DETAILED DESCRIPTION OF THE INVENTION

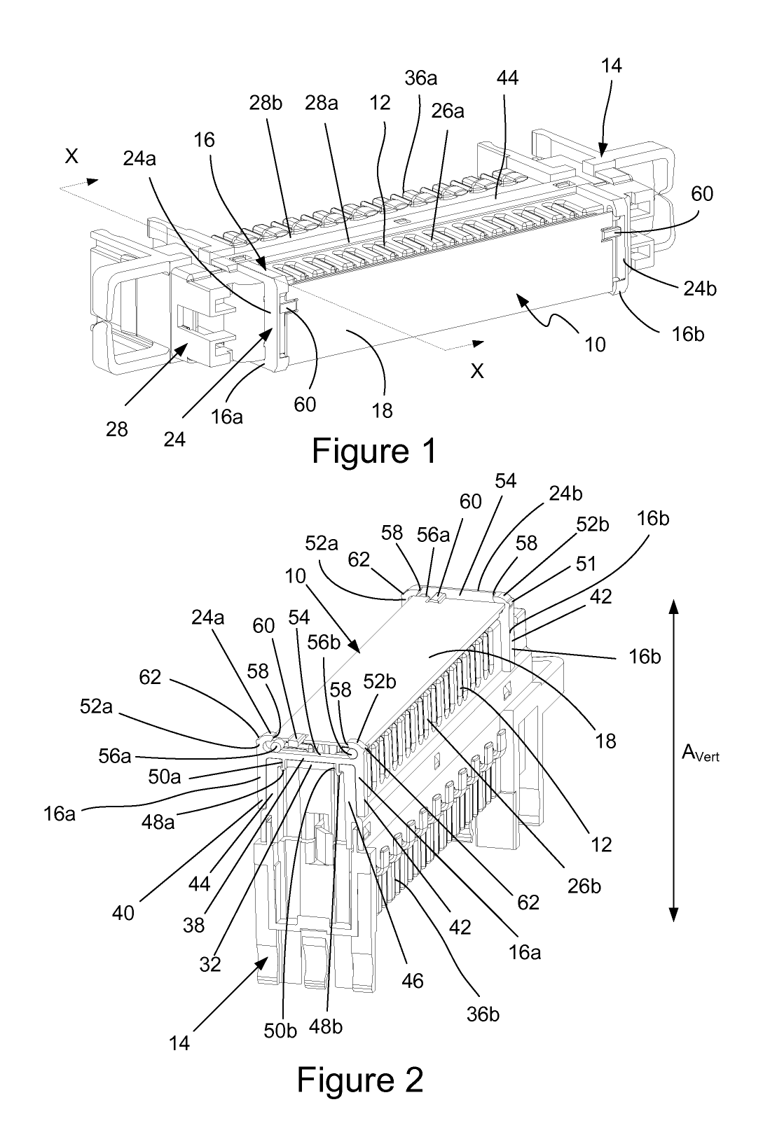

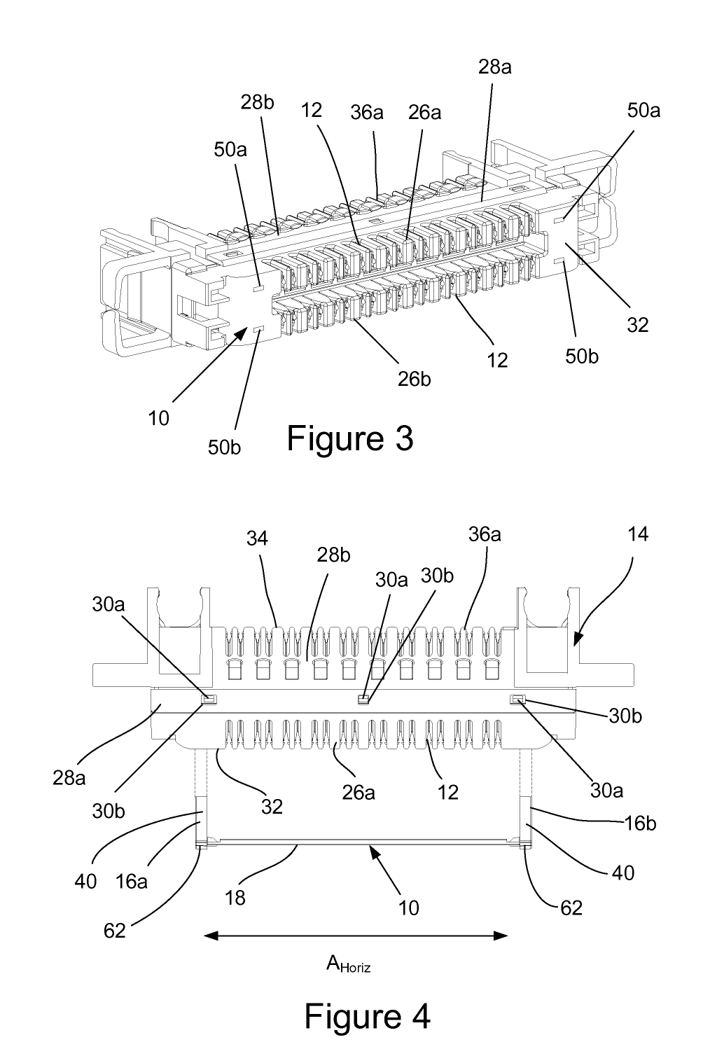

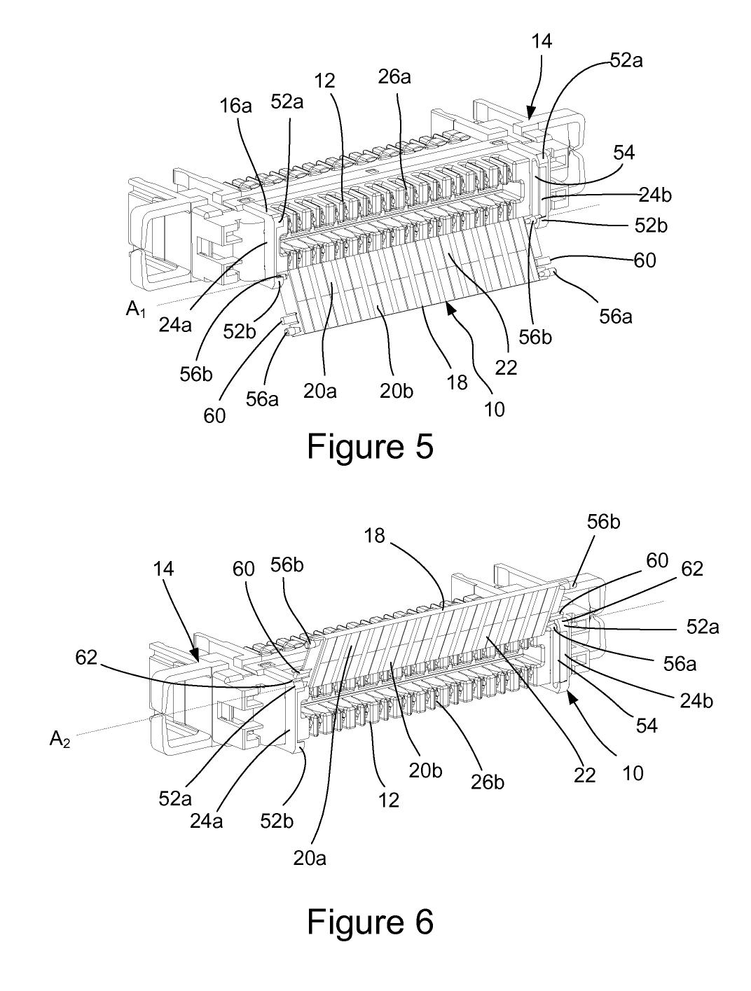

The labelling assembly 10 shown in FIGS. 1, 2, and 4 to 6 is used to identify wire connection locations 12 of the wire termination module 14 shown in FIG. 3. The labelling assembly 10 includes a fastener 16 for coupling the assembly 10 to the module 14; a label member 18 for bearing labelling indicia for identifying the wire connection locations 12; and a bracket 24 for supporting the label member 18 in a position overlying the wire connection locations in the manner shown in FIG. 1. The bracket 24 is adapted to support the label member 18 in a first position, as shown in FIG. 5, where a first row 26a of said wire connection locations 12 is laid open for external connection to insulated conductors (not shown). The bracket 24 is also adapted to be arranged in a second position, as shown in FIG. 6, where a second row 26b of wire connection locations 12 is laid open for external connection to insulated conductors (not shown).

The label member 18 is a generally rectangular label plate 18 having a first row 20a and a second row 20b of predetermined areas 22 for bearing labelling indicia. When arranged in the first position shown in FIG. 5, predetermined areas 22 of the first row 20a of predetermined areas are located in positions corresponding with wire connection locations 12 of a first row 26a of wire connection locations 22 of the module 14. When arranged in the second position shown in FIG. 6, predetermined areas 22 of the second row 20b of predetermined areas 22 are located in positions corresponding with wire connection locations 12 of a second row 26b of wire connection locations 12 of the module 14. The predetermined areas 22 of the first row 20a of predetermined areas 22 are located adjacent corresponding wire connection locations 12 of the first row 26a of wire connections locations 12 when the plate 18 is arranged in the first position. Similarly, the predetermined areas 22 of the second row 20b of predetermined areas 22 are located adjacent corresponding wire connection locations 12 of the second row 26b of wire connections locations 12 when the plate 18 is arranged in the second position.

The labelling indicia of the predetermined areas 22 includes a sequence of letters and/or numbers. Alternatively, the labelling indicia of the predetermined areas 22 includes a sequence of colors. Otherwise, the labelling indicia of the predetermined areas 22 includes any other suitable indicia for distinguishing one predetermined area 22 from another. The predetermined areas of the label member 18 are preferably formed on a removable card couplable to the rectangular label member 18.

As particularly shown in FIGS. 3 and 4, the wire termination module 14, also referred to as a cross-connect block, includes a housing 28 formed in front and back parts 28a, 28b coupled together by corresponding male and female parts of clips 30a, 30b. The above-described first and second rows 26a, 26b of wire connection locations 12 are arranged in parallel on a front side 32 of the front part 28a of the housing 28. The wire connection locations 12 are preferably insulation displacement contact slots. Each row 26a, 26b includes ten pairs of slots 12, where each slot 12 is shaped to receive a terminal end section of a wire. Similarly, a back side 34 of the back part 28b of the housing 28 includes two parallel rows 36a, 36b of wire connection locations 12. Each row includes ten pairs of slots 12 where each slot 12 is shaped to receive a terminal end section of wire of an unshielded twisted pair.

The module 10 includes electrically conductive contacts (not shown) extending between corresponding wire connection locations 12 in the front and back parts 28a, 28b of the housing 28. Each contact includes an insulation displacement contact seated in a wire connection location 12 in the front part 28a of the housing 28 and an insulation displacement contact seated in a corresponding wire connection location 12 in the back part of the housing 28. Opposed contacts in the first and second rows 26a, 26b of wire connection locations 12 are preferably in electrical communication by way of spring finger contacts extending therebetween. Thus, an insulated conductor electrically connected to a contact in the first row 26a is electrically connected to another insulated conductor electrically connected to a contact in the second row 26b.

The labelling assembly 10 is hereafter described, by way of non-limiting example, to the module 10 shown in FIGS. 1 to 6. However, the labelling assembly is suitable for use with any other wire termination module that includes first and second rows 26a, 26b of wire connection locations 12.

The labelling assembly 10 is coupled to the front part 28a of the housing 28 by the fastener 16. As particularly shown in FIG. 2, the fastener 16 includes two fastener parts 16a, 16b located on opposite ends of the front part 28a of the housing 28. Each part 16a, 16b includes an elongate front member 38 extending across the front side 32 of the front part 28a of the housing between elongate top and bottom members 40, 42. When the fastener 16 is fitted to the module 14, the members 38, 40, 42 respectively overlie the front, top and bottom sides 32, 44, 46 of the front part 28a of the housing 28. The top and bottom members 40, 44 preferably resiliently bear against the top and bottom sides 44, 46 of the module 14 and inhibit movement of the labelling assembly along a vertical axis “A_{Vert}”. The front member 38 includes two male projections 48a, 48b that extend in parallel into corresponding recesses 50a, 50b formed in the front side 32 of the front part 28a of the housing 28. The projections 48a, 48b include locking surfaces that mate with corresponding locking surfaces in recesses 50a, 50b and thereby resiliently couple the assembly 10 to the module 14.

The fastener parts 16a, 16b work together to inhibit transverse movement of the assembly 10 along a horizontal axis “A_{Horiz}” with respect to the housing 28. The top and bottom members 40, 42 are preferably provided with lugs (not shown) which are shaped for insertion into corresponding recesses (not shown) formed in the top and bottom sides 44, 46 of the housing 28. The lugs further inhibit movement of the assembly 10 with respect to the module 14.

The label plate 18 is coupled to the fastener 16 by the bracket 24. As particularly shown in FIG. 2, the bracket 24 is formed in two bracket parts 24a, 24, each being conterminous with a front member 38 of a corresponding fastener part 16a, 16b. The bracket parts 24a, 24b are preferably formed integrally with the fastener parts 16a, 16b. Alternatively, the bracket parts are coupled to but formed separately with the fastener parts 16a, 16b.

Each bracket part 24a, 24b includes two “C” shaped clasps 52a, 52b arranged on opposite ends of the front member 38. The clasps 52a, 52b open towards each other to define ends of an open channel 54. An outer peripheral surface of the top member 38 extends between the clasps 52a, 52b and defines an inner articular surface of the channel 54 along which pairs of lugs 56a, 56b of the label plate 18 are adapted to translate. The pairs of lugs 56a, 56b extend in parallel away from opposite short ends of the rectangular label plate 18.

The label plate 18 is coupled to the bracket 24 when the pairs of lugs 56a, 56b are seated in respective channels 54 of the bracket parts 24a, 24b in the manner shown in FIG. 1, for example. The lugs 56a, 56b of each pair are arranged in spaced apart positions so that when the second lug 56b of the pair of lugs is seated in the cusp of the “C” shaped clasp 52b in the manner shown in FIG. 2, the first lug 56a is located at the open end of the opposite “C” shaped clasp 52a. In this position, the open end of the clasp 52a at least partially bears against the lug 52a and inhibits its removal from the channel 54. Similarly, when the first lug 56a of the pair of lugs is seated in the cusp of the “C” shaped clasp 52a, the second lug 56b is located at the open end of the opposite “C” shaped clasp 52b. In this position, the open end of the clasp 52b at least partially bears against the lug 52b and inhibits its removal from the channel 54. In the above described arrangement, the label plate 18 overlies the front side 32 of the housing 28.

Open ends of the “C” shaped clasps 52a, 52b includes chamfer end sections 58 that assist with insertion/removal of the lugs 56a, 56b into/from the open channel 24 of the bracket parts 24a, 24b. The chamfer end sections 58 of the clasps 52a, 52b are resiliently flexible and bend under the influence of a lug 56a, 56b being forced into, or out of, the channel 54.

In the example shown in FIG. 5, the lugs 56a extending from opposite ends of the label plate 18 have been removed from respective channels 54 of the bracket parts 24a, 24b and the lugs 56b extending from opposite ends of the plate 18 are seated in cusps of the “C” shaped clasps 52b of the bracket parts 24a, 24b. Further, the label plate 18 has been rotated about an axis “A₁” defined between the lugs 56b extending from opposite ends of the label plate 18. Rotation of the plate 18 about the axis “A₁” is limited by a bottom edge of the plate 18 abutting the front side 32 of the housing 28. When the module 14 is mounted on a Profil™ racking system (not shown), the label plate 18 sits under the influence of gravity in the manner shown in FIG. 5.

When the plate 18 is arranged in the above described manner, the labelling assembly 10 can be used by a technician to identify wire connection locations 12 of the wire termination module 14. That is, the bracket 24 is adapted to move the plate 18 from the first position shown in FIG. 1 to the position shown in FIG. 5 where the predetermined areas 22 of the first row 20a of predetermined areas are located in positions corresponding with wire connection locations 12 of the first row 26a of wire connections locations 22 of the module 14. When so arranged, the predetermined areas 22 of the first row 20a of predetermined areas 22 are located adjacent corresponding wire connection locations 12 of the first row 26a of wire connections locations 12.

In the example shown in FIG. 6, the lugs 56b extending from opposite ends of the label plate 18 have been removed from respective channels 54 of the bracket parts 24a, 24b and the lugs 56a extending from opposite ends of the plate 18 are seated in cusps of the “C” shaped clasps 52a of the bracket parts 24a, 24b. Further, the label plate 18 has been rotated about an axis “A₂” defined between the lugs 56a extending from opposite ends of the label plate 18 seated in respective clasps 52a of the bracket parts 24a, 24b. Rotation of the plate 18 about the axis “A₂” is limited by a top edge of the plate 18 abutting the front side 32 of the housing 28. When the module 14 is coupled to a Profil™ racking system (not shown), the label plate 18 will have a tendency to fall under the influence of gravity so as to overlie the front side of the housing 28. In order to prop the label plate 18 up in manner shown in FIG. 6, opposite ends of the plate 18 include propping lugs 60 extending in parallel outwardly from between respective pairs of lugs 56a, 56b. The open ends of the clasps 52a of the bracket parts 24a, 24b are shaped to extend through gaps between lugs 56a and 60. Upper sections of the clasps 52a of each bracket part 24a, 24b include stopping protrusions 62 shaped to resiliently pass between the gaps between the lugs 56a, 60 of each end of the plate 18. The stopping protrusions 62 pass through the gaps between the lugs 56a, 60 under the influence of a force greater than the downward gravitational force of the label plate 18. The stopping protrusions 62 thereby prop the label plate up in the manner shown in FIG. 6.

When the plate 18 is arranged in the manner shown in FIG. 6, the labelling assembly 10 can be used by a technician to identify wire connection locations 12 of the wire termination module 14. That is, the bracket 24 is adapted to move the plate 18 from the first position shown in FIG. 1 to the position shown in FIG. 6 where the predetermined areas 22 of the second row 20b of predetermined areas are located in positions corresponding with wire connection locations 12 of the second row 26b of wire connections locations 22 of the module 14. When so arranged, the predetermined areas 22 of the second row 20b of predetermined areas 22 are preferably located adjacent corresponding wire connection locations 12 of the second row 26b of wire connections locations 12.

In order to uniquely identify a particular wire connection location 12 in the first row 26a of the module 14, a technician can perform the following steps:
a. Arrange the label plate 18 in the first position shown in FIG. 5;
b. Identify the predetermined area 22 for bearing labelling indicia bearing the labelling indicia corresponding to the desired wire connection location off the plate 18; and
c. Identify the wire connection location 12 adjacent the aforementioned predetermined area 22 for bearing labelling indicia.

In order to uniquely identify a particular wire connection location 12 in the second row 26b of the module 14, a technician can perform the following steps:
a. Arrange the label plate 18 in the second position shown in FIG. 6;
b. Identify the predetermined area 22 for bearing labelling indicia bearing the labelling indicia corresponding to the desired wire connection location off the plate 18; and
c. Identify the wire connection location 12 adjacent the aforementioned predetermined area 22 for bearing labelling indicia.

A lookup table preferably accompanies the labelling assembly 10. An example of the lookup table for pairs of wire connection locations 12 for the module 14 is set out below:

| | Indicia | Indicia |
|---|---|---|
| Line usage | First Row | Second Row |
| Telephone line Ross' office | A1 | B1 |
| Facsimile line Ross' office | A2 | B2 |
| Telephone line Sam' office | A3 | B3 |
| Facsimile line Sam's office | A4 | B4 |
| Telephone line Mark's office | A5 | B5 |
| Facsimile line Mark's office | A6 | B6 |
| Telephone line Geoff's office | A7 | B7 |
| Facsimile line Geoff's office | A8 | B8 |
| Telephone line Keith's office | A9 | B9 |
| Facsimile line Keith's office | A10 | B10 |

As above-described, the label plate 18 includes a first row 20a and a second row 20b of predetermined areas 22 for bearing labelling indicia. The two rows 20a, 20b are located on a common first side of the plate 18. In a further embodiment, the opposite side of the plate 18 also includes a first row (not shown) and a second row (not shown) of predetermined areas 22 for bearing labelling indicia. In this embodiment, the first and second rows of predetermined areas 22 for bearing labelling indicia on the opposite side of the plate 18 are located adjacent corresponding wire connection locations 12 when the first side of the plate 18 overlies the front side 32 of the housing 28 in the manner shown in FIG. 1. A technician can read the indicia on the opposite side of the plate 18 to identify each wire connection location 12 in the first and second rows 26a, 26b of wire connection locations 12.

In this embodiment, the plate 18 can be removed from the bracket 24 and reattached with the opposite side overlying the front 32 of the housing 28. In doing, so the first and second rows of predetermined areas 22 for bearing indicia on the opposite side of the plate 18 can be arranged as shown in FIGS. 5 and 6.

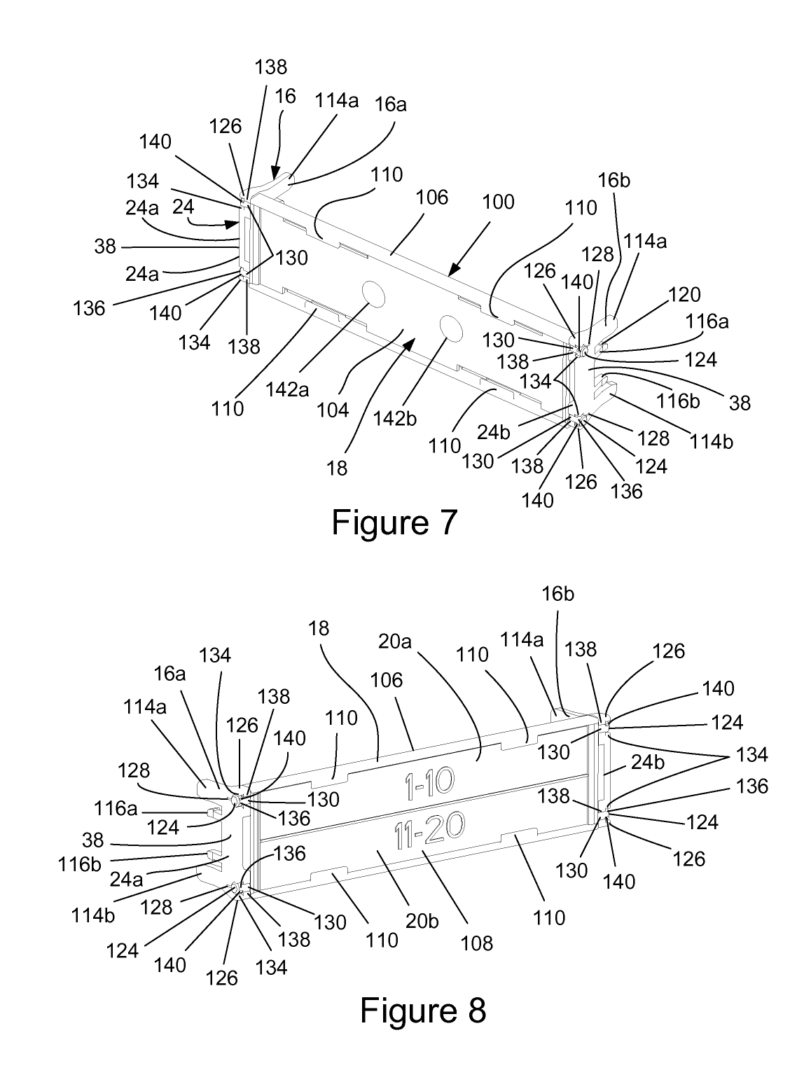

The labelling assembly 100 shown in FIGS. 7 to 13 is used to identify wire connection locations 12 of a wire termination module 102. The labelling assembly operates in a similar manner to that of the labelling assembly 10 and like parts are identified with like reference numerals in FIGS. 7 to 13.

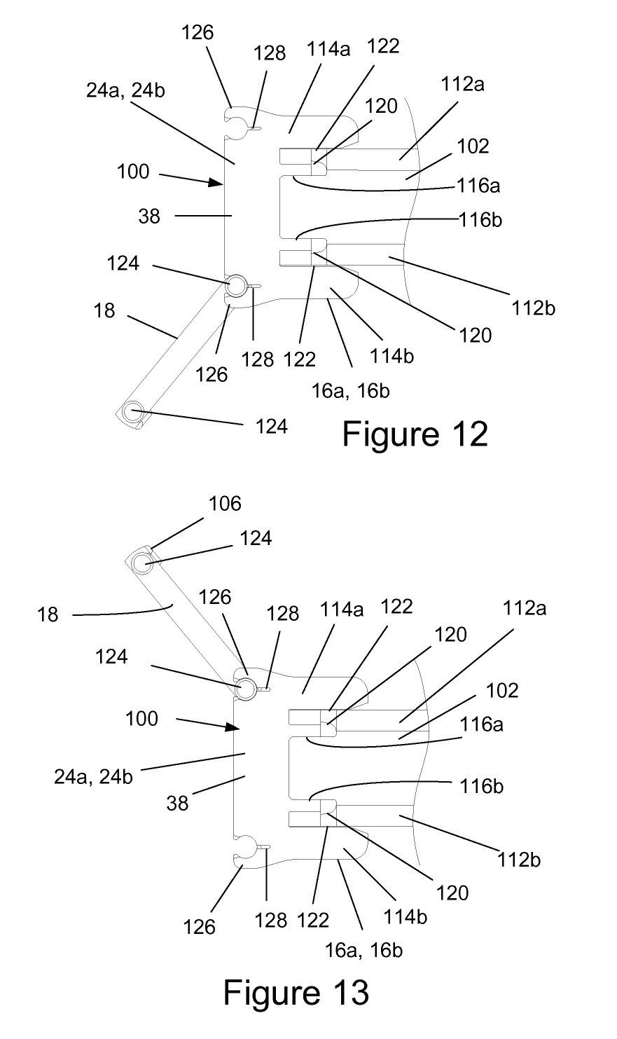

The labelling assembly 100 includes a fastener 16 for coupling the assembly 100 to the module 102; a label member 18 for bearing labelling indicia for identifying the wire connection locations 12; and a bracket 24 for supporting the label member 18 in a position overlying the wire connection locations 12. The bracket 24 is adapted to support the label member 18 in a first position, as shown in FIG. 12, where a first row 26a of said wire connection locations 12 is laid open for external connection to insulated conductors (not shown). The bracket 24 is also adapted to support the label member 18 in a second position, as shown in FIG. 13, where a second row 26b of wire connection locations 12 is laid open for external connection to insulated conductors.

The label member 18 includes a generally planar rectangular label bearing section 104 which is framed by a label supporting section 106. The label supporting section 106 includes tabs 110 extending over a common side of the label bearing section 104. The card 108 is coupled to the label member 18 by inserting opposed long sides of the rectangular card 108 under the tabs 110 so that the card 108 overlies the label bearing section 104 in the manner shown in FIG. 8.

The card 108 includes a first row 20a and a second row 20b of predetermined areas for bearing labelling indicia. When arranged in the first position shown in FIG. 12, predetermined areas of the first row 20a of predetermined areas are located in positions corresponding with wire connection locations 12 of a first row 26a of wire connection locations 12 of the module 102. When arranged in the second position shown in FIG. 13, predetermined areas of the second row 20b of predetermined areas are located in positions corresponding with wire connection locations 12 of the second row 26b of wire connection locations 12 of the module 102. For example, the predetermined areas of the first row 20a of predetermined areas are located adjacent corresponding wire connection locations 12 of the first row 26a of wire connections locations 12 when the plate 18 is arranged in the first position. Similarly, the predetermined areas of the second row 20b of predetermined areas 22 are located adjacent corresponding wire connection locations 12 of the second row 26b of wire connections locations 12 when the plate 18 is arranged in the second position.

The labelling indicia of the predetermined areas preferably includes a sequence of letters and/or numbers. Alternatively, the labelling indicia of the predetermined areas includes a sequence of colors. Otherwise, the labelling indicia of the predetermined areas includes any other suitable indicia for distinguishing one predetermined area from another.

The label supporting section 106 preferably includes further tabs (not shown) extending over an opposite side of the label bearing section 104. The card 108 can be coupled to the opposite side of the label member 18 by inserting opposed long sides of the rectangular card 108 under the further tabs (not shown) so that the card 108 overlies the opposite side of the label bearing section 104.

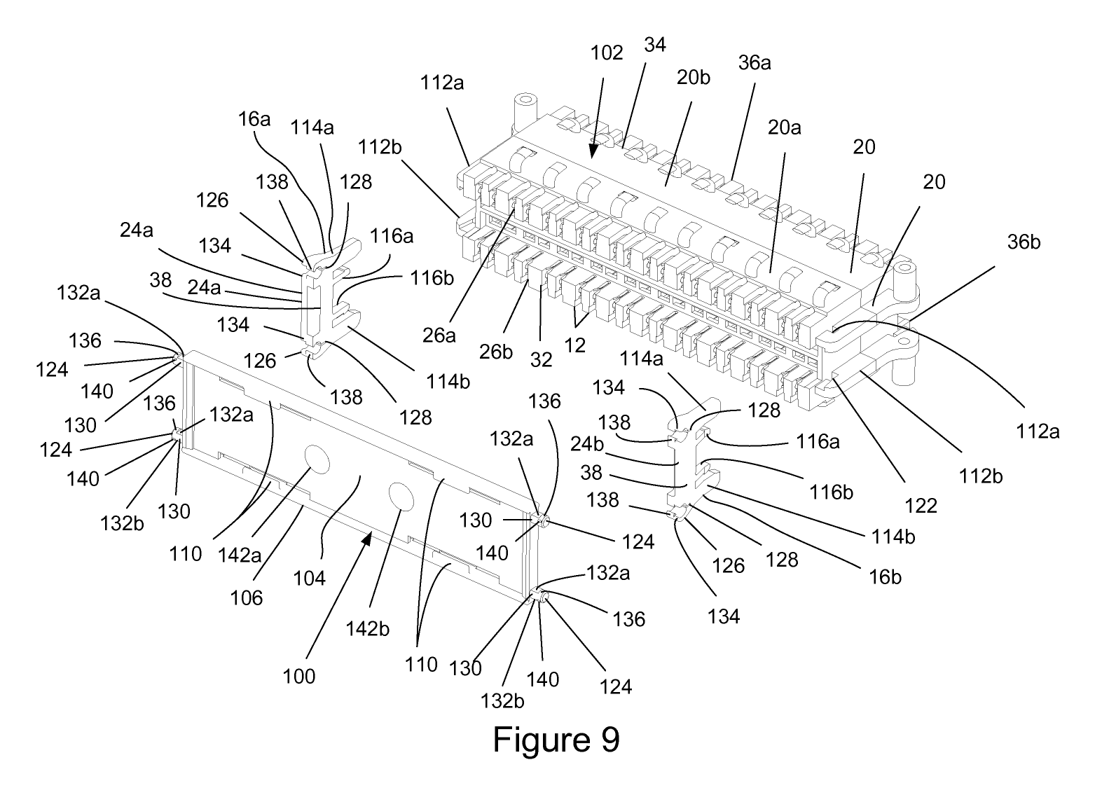

As particularly shown in FIG. 9, the wire termination module 102, also referred to as a cross-connect block, includes a housing 28 formed in front and back parts 28a, 28b coupled together by corresponding male and female parts of clips (not shown). The above-described first and second rows 26a, 26b of wire connection locations 12 are arranged in parallel on a front side 32 of the front part 28a of the housing 28. The wire connection locations 12 are preferably insulation displacement contact slots. Each row 26a, 26b includes ten pairs of slots 12, where each slot 12 is shaped to receive a terminal end section of a wire (not shown). Similarly, a back side 34 of the back part 28b of the housing 28 includes two parallel rows 36a, 36b of wire connection locations 12. Each row includes ten pairs of slots 12 where each slot 12 is shaped to receive a terminal end section of wire of an unshielded twisted pair (not shown). The module 102 includes electrically conductive contacts (not shown) extending between corresponding wire connection locations 12 in the front and back parts 28a, 28b of the housing 28. Each contact includes an insulation displacement contact seated in a wire connection location 12 in the front part 28a of the housing 28 and an insulation displacement contact seated in a corresponding wire connection location 12 in the back part of the housing 28.

The labelling assembly 100 is hereafter described, by way of non-limiting example, to the module 102 shown in FIGS. 9 to 13. However, the labelling assembly 100 is suitable for use with any other wire termination module that includes the above described arrangement of wire connection locations 12.

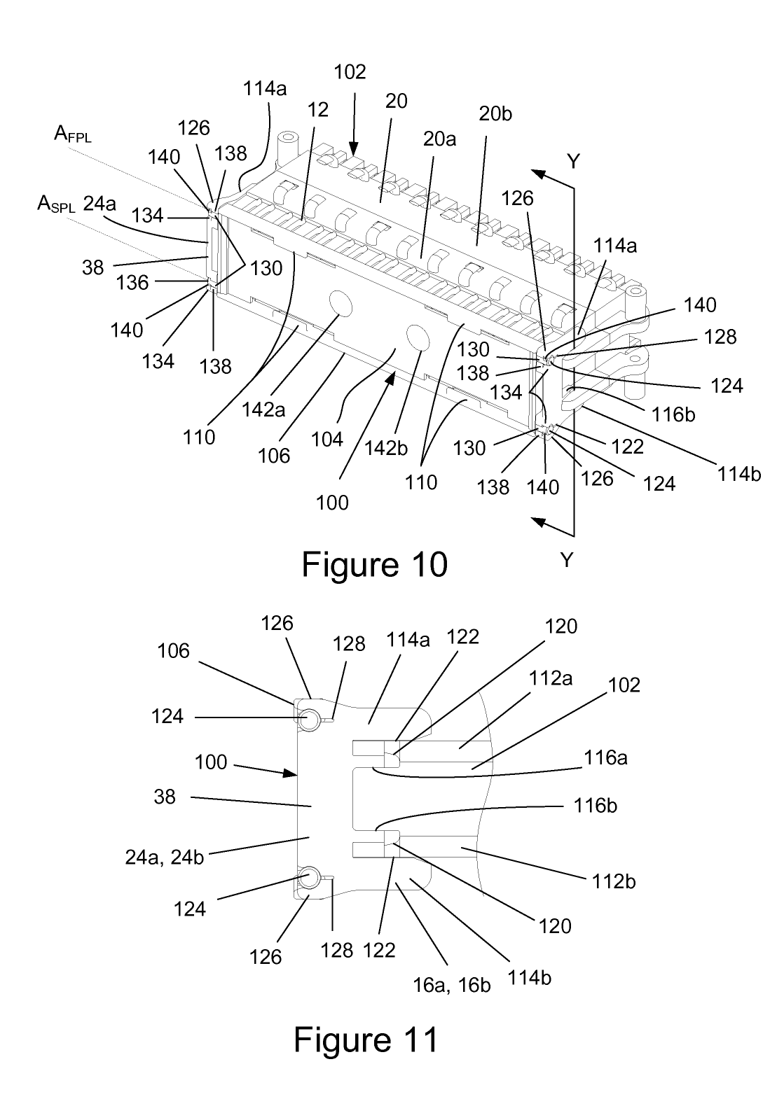

The labelling assembly 100 is coupled to the front part 28a of the housing 28 by the fastener 16. As particularly shown in FIG. 9, the fastener 16 includes two fastener parts 16a, 16b, each being coupleable to respective pairs of spaced apart flanges 112a, 112b extending in parallel between the front and back parts 28a, 28b of the housing 28. As particularly shown in FIG. 11, the fastener parts 16a, 16b each include:
a. An elongate front member 38 bridging a gap between a front end section of the flanges 112a, 112b;
b. A pair of elongate outer members 114a, 114b extending in parallel from respective end sections of the elongate front member 38 so as to overlie outer peripheral surfaces of respective flanges 112a, 112b; and
c. A pair of elongate inner members 116a, 116b extending in parallel from respective inner sections of the elongate front member 38 so as to overlie inner peripheral surfaces or respective flanges 112a, 112b.

Distal end sections of the inner members 116a, 116b include locking surfaces 120 shaped for at least partial insertion into corresponding slots 122 formed in inner peripheral surfaces of the flanges 112a, 112b. The locking surfaces 120 are seated in respective slots 122 when the labelling assembly is fitted to the front part 28a of the housing 28 in a manner whereby the elongate front members 38 of the fastener parts 16a, 16b abut front end sections of the flanges 112a, 112b. The labelling assembly 100 is thereby coupled to the module 102. When the fastener 16 is fitted to the module 102, the outer members 114a, 114b overlie and resiliently bear against the flanges 112a, 112b and inhibit transverse movement of the labelling assembly 100 with respect to the module 102.

The label plate 18 is coupled to the fastener 16 by the bracket 24. As particularly shown in FIG. 9, the bracket 24 is formed in two bracket parts 24a, 24, each being conterminous with a front member 38 of a corresponding fastener part 16a, 16b. The bracket parts 24a, 24b are preferably formed integrally with the fastener parts 16a, 16b. Alternatively, the bracket parts are coupled to but formed separately with the fastener parts 16a, 16b.

The label member 18 is coupled between the bracket parts 24a, 24b by pairs of lugs 124 extending in parallel away from opposite short end sections of the rectangular label member 18. The bracket parts 24a, 24b include pairs of clasps 126 shaped to at least partially receive respective pairs of lugs 124. The clasps 126 are “C” shaped and open in a common direction, normal to a planar surface of the label member. The clasps 126 include rearward slots 128 being resiliently expandable so that opposed arms of the “C” shaped clasps 126 resiliently open as the lugs 124 are forced therebetween.

The lugs 124 are generally cylindrical protrusions. Proximal sections 130 of the generally cylindrical lugs 124 include oppositely facing sectioned planar surfaces 132a, 132b. The planar surfaces 132a, 132b of the lugs 124 are preferably normal to a planar surface of the label member 18. The proximal sections 130 of the lugs 124 are adapted to rotate axially within respective first sections 134 of the clasps 126. The planar surfaces 132a, 132b of the lugs 124 are shaped to resiliently pass through open ends of the first sections 134 of the clasps 126 to facilitate removal of the label member 18 from the brackets 24a, 24b.

The cylindrical distal end sections 136 of the lugs 124 are adapted to rotate axially within respective second sections 138 of the clasps 126. The distal end sections 136 of the lugs 124 include locking protrusions 140 shaped for location in respective slots 128 as the lugs 124 rotate about respective second sections 138 of the clasps 126.

The label member 18 overlies the wire connection locations 12 of the module 102 when the pairs of lugs 124 are seated in corresponding pairs of clasps 126. The label member 18 is adapted to rotate towards the first position, shown in FIG. 12 where the first row 26a of said wire connection locations 12 is laid open for external connection to insulated conductors (not shown), when a first pair of axially aligned lugs 124 are removed from respective clasps 126 and the label member 18 rotates about an axis “A_{SPL}” defined by a second pair of axially aligned lugs 124. The label member 18 is supported in the first position when locking protrusions 140 of the second pair of axially aligned lugs 124 are seated in slots 128 of the corresponding clasps 126.

The label member 18 is adapted to rotate towards the second position, shown in FIG. 13 where the second row 26b of wire connection locations 12 is laid open for external connection to insulated conductors (not shown), when the second pair of axially aligned lugs 124 are removed from respective clasps 126 and the label member 18 rotates about an axis “A_{FPL}” defined by the first pair of axially aligned lugs 124. The label member 18 is supported in the second position when locking protrusions 140 of the first pair of axially aligned lugs 124 are seated in slots 128 of the corresponding clasps 126.

As particularly shown in FIG. 7, the label member 18 includes two apertures 142a, 142b to assist in removal of the card 108 from the label supporting section 106.

Many modifications will be apparent to those skilled in the art without departing from the scope of the present invention as hereinbefore described with reference to the accompanying drawings.

Throughout this specification and claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

### LIST OF PARTS

10 Labelling assembly
12 Wire connection location
14 Wire termination module
16 Fastener
18 Label member, label plate
20a First row of predetermined areas for labelling wire connection locations
20b Second row of predetermined areas for labelling wire connection locations
22 Predetermined area for labelling wire connection location
24 Bracket
24a, 24b Bracket part
26a First row of wire connection locations
26b Second row of wire connection locations
28 Housing
28a Front part of housing
28b Back part of housing
30a Male clip
30b Female clip
32 Front side of housing
34 Back side of housing
36a Row of wire connection locations
36b Row of wire connection locations
38 Front member of fastener
40 Top member of fastener
42 Bottom member of fastener
44 Top side of housing
46 Bottom side of housing
48a Male projection
48b Recess
50a, 50b Recess
52a, 52b “C” shaped clasp
54 Channel
56a, 56b Lug
58 Chamfer end section
60 Propping lug
62 Stopping protrusion
100 Labelling assembly
102 Wire termination module
104 Label bearing section
106 Label supporting section
108 Card
110 Tab
112a, 112b Flange
114a, 114b Elongate outer member
116a, 116b Elongate inner member
120 Locking surface
122 Slot
124 Lug
126 Clasp
128 Rearward slot
130 Proximal end section of lug
132a, 132b Planar surface
134 First section of clasp
136 Distal end section of lug
138 Second section of clasp
140 locking protrusion
142a, 142b Aperture

1. A labelling assembly for identifying wire connection locations of a wire termination module, including:
(a) a fastener for coupling the assembly to the module;
(b) a label member for bearing labelling indicia for identifying the wire connection locations; and
(c) a bracket for supporting the label member in a position overlying the wire connection locations,
wherein the bracket is adapted to support the label member in a first position where a first row of said wire connection locations is laid open for external connection to insulated conductors and a second position where a second row of said wire connection locations is laid open for external connection to insulated conductors.

2. The labelling assembly claimed in claim 1, wherein the label member is a generally rectangular plate.

3. The labelling assembly claimed in claim 1, wherein the label member is a generally rectangular frame shaped to receive and display a card bearing labelling indicia.

4. The labelling assembly claimed in claim 1, wherein the bracket includes first and second bracket parts being couplable to opposite end sections of the module.

5. The labelling assembly claimed in claim 4, wherein the label member is coupled between the bracket parts by pairs of lugs extending in parallel away from opposite short end sections of the rectangular label member.

6. The labelling assembly claimed in claim 5, wherein the bracket parts include pairs of clasps shaped to at least partially receive respective lugs of said pairs of lugs.

7. The labelling assembly claimed in claim 6, wherein the clasps are “C” shaped and open in a common direction, normal to a planar surface of the label member.

8. The labelling assembly claimed in claim 7, wherein the clasps include rearward slots, the slots being resiliently expandable so that opposed arms of the “C” shaped clasps resiliently open as the lugs are forced therebetween.

9. The labelling assembly claimed in claim 6, wherein the lugs are generally cylindrical protrusions.

10. The labelling assembly claimed in claim 9, wherein proximal sections of the generally cylindrical lugs include oppositely facing sectioned planar surfaces.

11. The labelling assembly claimed in claim 10, wherein the planar surfaces of the lugs are normal to a planar surface of the label member.

12. The labelling assembly claimed in claim 11, wherein the proximal sections of the lugs are adapted to rotate axially within respective first sections of the clasps.

13. The labelling assembly claimed in claim 10, wherein the planar surfaces of the lugs are shaped to resiliently pass through open ends of the first sections of the clasps to facilitate removal of the label member from the brackets.

14. The labelling assembly claimed in claim 13, wherein the cylindrical distal end sections of the lugs are adapted to rotate axially within respective second sections of the clasps.

15. The labelling assembly claimed in claim 14, wherein the distal end sections of the lugs include protrusions shaped for location in respective slots as the lugs rotate about respective second sections of the clasps.

16. The labelling assembly claimed in claim 6, wherein the label member overlies the wire connection locations when the pairs of lugs are seated in corresponding pairs of clasps.

17. The labelling assembly claimed in claim 14, wherein the label member is adapted to rotate towards the first position where the first row of said wire connection locations is laid open for external connection to insulated conductors when a first pair of axially aligned lugs of said lugs are removed from respective clasps and the label member rotates about an axis defined by a second pair of axially aligned lugs of said lugs.

18. The labelling assembly claimed in claim 18, wherein the label member is supported in the first position when protrusions of the second pair of axially aligned lugs are seated in slots of the corresponding clasps.

19. The labelling assembly claimed in claim 14, wherein the label member is adapted to rotate towards the second position where the second row of said wire connection locations is laid open for external connection to insulated conductors when the second pair of axially aligned lugs of said lugs are removed from respective clasps and the label member rotates about an axis defined by the first pair of axially aligned lugs of said lugs.

20. The labelling assembly claimed in claim 20, wherein the label member is supported in the second position when protrusions of the first pair of axially aligned lugs are seated in slots of the corresponding clasps.

21. The labelling assembly claimed in claim 1, wherein the label member is adapted to bear a card bearing indicia for identifying the wire connection locations.

22. The labelling assembly claimed in claim 4, wherein the fastener parts each include elongate spaced apart male projections, shaped to extend resiliently between corresponding spaced apart locking surfaces.

23. The labelling assembly claimed in claim 5, wherein the pairs of lugs are adapted to translate along respective channels of the bracket parts.

24. The labelling assembly claimed in claim 24, wherein the label member overlies the first row and the second row of wire connection locations when the pairs of lugs are located in corresponding channels of the bracket parts.

25. The labelling assembly claimed in claim 24, wherein the channels of the bracket are at least partially open so as to permit removal or insertion of the pairs of lugs.

26. The labelling assembly claimed in claim 26, wherein opposed ends of the channels of the bracket parts are closed by “C” shaped clasps.

27. The labelling assembly claimed in claim 27, wherein the label member is adapted to rotate about a first axis defined by axially aligned lugs of said pairs of lugs extending from opposite end sections of the plate when the axially aligned lugs are seated in corresponding “C” shaped clasps of the bracket parts.

28. The labelling assembly claimed in claim 28, wherein the plate is adapted to rotate about said first axis so that the plate is located in the first position where the predetermined areas of the first row of predetermined areas are located in positions corresponding with wire connection locations of the first row of wire connections locations of the module.

29. The labelling assembly claimed in claim 28, wherein the plate is adapted to rotate about a second axis defined by other axially aligned lugs of said pairs of lugs extending from said opposite end sections of the plate when the axially aligned lugs are seated in other corresponding “C” shaped clasps of the bracket parts.

30. The labelling assembly claimed in claim 30, wherein the plate is adapted to rotate about said second axis so that the plate is located in the second position where the predetermined areas of the second row of predetermined areas are located in positions corresponding with wire connection locations of the second row of wire connections locations of the module.

31. The labelling assembly claimed in claim 31, wherein the plate includes a pair of propping lugs extending in parallel from said opposite end sections of the plate.

32. The labelling assembly claimed in claim 32, wherein said other corresponding “C” shaped clasps extend between said other axially aligned lugs and said propping lugs when the label plate is arranged in the second position.

33. The labelling assembly claimed in claim 33, wherein said other corresponding “C” shaped clasps include a resilient protrusion which resiliently inhibit passage of said other corresponding clasps between said other axially aligned lugs and said propping lugs when the label plate is moved towards the second position.

34. The labelling assembly claimed in claim 34, wherein the resilient protrusions inhibit the plate falling under the influence of gravity from the second position towards the first position.

35. The labelling assembly claimed in claim 24, wherein the fastener includes a plurality of male projections shaped for insertion into corresponding recesses formed in the housing of the module.

36. The labelling assembly claimed in claim 36, wherein the male projections include locking surfaces.

37. The labelling assembly claimed in claim 1, wherein the labelling indicia is alphabetic

38. The labelling assembly claimed in claim 1, wherein the labelling indicia is numeric.

39. The labelling assembly claimed in claim 1, wherein the labelling indicia is alphanumeric.

40. The labelling assembly claimed in claim 1, wherein the labelling indicia is a color coded.

41. A wire termination module, comprising:
(a) a housing formed in front and back parts;
(b) first and second rows of wire connection locations arranged in parallel on a common side of the housing; and
(c) a labelling assembly, including:
(1) a fastener for coupling the assembly to the housing;
(2) a label member for bearing labelling indicia for identifying the wire connection locations; and
(3) a bracket for supporting the label member in a position overlying the wire connection locations,
wherein the bracket is adapted to support the label member in a first position where a first row of said wire connection locations is laid open for external connection to insulated conductors and a second position where a second row of said wire connection locations is laid open for external connection to insulated conductors.
